(19) United States
(12) Patent Application Publication
(10) Pub. No.: US 2007/0012817 A1
(43) Pub. Date: Jan. 18, 2007

(54) Multi-medium vehicle systems

(76) Inventor: Daniel W. Parmley SR., Phoenix, AZ (US)

Correspondence Address: Keith L. Jenkins;Registered Patent Attorney, LLC, #2069, 2222 N. McQueen Road, Chandler, AZ, 85225, US

(21) Appl. No.: 11/202,525

(22) Filed: Aug. 12, 2005

Related U.S. Application Data
(60) Provisional application No. 60/601,521, filed on Aug. 13, 2004.
(60) Provisional application No. 60/616,199, filed on Oct. 4, 2004.
(60) Provisional application No. 60/601,521, filed on Aug. 13, 2004.

(51) Int. Cl. B64C 37/02

(52) U.S. Cl. 244/2

(57) ABSTRACT

A multi-medium vehicle system is disclosed which uses a common controller to at least partially control each of a plurality of vehicles to move a common payload through multiple transportation mediums. Each vehicle may be designed for a particular transportation medium, such as air, land, water or other medium. The vehicles may be coupled together to share the common controller and may uncouple for transportation purposes. The vehicle that delivers the payload to the destination remains coupled to the common controller, while other vehicles may uncouple from the common controller before delivery. A method of use is also disclosed.

### CROSS-REFERENCES TO RELATED APPLICATIONS

This application claims the benefit of U.S. Provisional Application No. 60/601,521 filed Aug. 13, 2004 and further claims the benefit of U.S. Provisional Application No. 60/616,199, filed 10-04-2004 for subject matter not covered in U.S. Provisional Application No. 60/601,521 filed Aug. 13, 2004, if any.

### FIELD OF THE INVENTION

The present invention relates to systems that include multiple vehicles, each vehicle of which is adapted to one or more transportation mediums, such as, for example, air, land, and water. Each vehicle in a particular system uses an adaptive common controller that can be interchangeably used with each of the other vehicles among the multiple vehicles of a particular system. The common controller provides at least partial control capabilities for each vehicle among the multiple vehicles of a particular system, and may be expanded to include navigation, communication, augmented propulsion, and control of one or more operational payloads.

### BACKGROUND OF THE INVENTION

Modern governmental, civil and exploratory operations may benefit from the capability of operating in various transportation mediums, such as land, air, sea, outer space, upper atmosphere, marsh, swamp, lake, mountain, rough terrain, celestial body surfaces other than Earth's, and desert mediums. A number of hybrid vehicles have been developed, including seaplanes, airliners, and amphibious landing craft, which can operate in multiple transportation mediums. Each of these vehicles suffers a performance penalty in each transportation medium in exchange for the capability to operate in the other transportation medium. There is typically a single control system on each of these vehicles that is capable of enabling control of the vehicle in both transportation mediums.

What is lacking in the hybrid vehicles is the capability to carry a single operational payload through multiple mediums in multiple vehicles each adapted specifically for high performance in their respective mediums. One problem in developing such a capability is cost. A significant factor in cost is the control technology for the vehicle. Especially for remotely operated vehicles and their payloads, the cost of control technology, including the supporting navigation and communication capabilities, can be very high, and must be paid separately for each vehicle.

What is needed are multi-medium vehicle systems each using a commonly interchangeable controller that can be physically transferred from one vehicle to another. Also needed are multi-medium vehicle systems using a commonly interchangeable controller with supporting communications and navigation capabilities. Yet a further need is for multi-medium vehicle systems using a commonly interchangeable controller with supporting communications, navigation capabilities, and operational payload. Yet even a further need is for multi-medium vehicle systems using a commonly interchangeable controller that can couple to two or more vehicles simultaneously for docking, transfer, and transport. To meet the above-mentioned needs and to solve the above-mentioned problems, applicant presents what follows.

### BRIEF SUMMARY OF THE INVENTION

One embodiment of the present invention provides an airship operable to dock with and transfer its controller and an operational payload to an amphibious vehicle. A second embodiment of the present invention provides an airship operable to dock with and transfer its controller and an operational payload to a land vehicle. A method of docking is provided.

### BRIEF DESCRIPTION OF THE DRAWINGS

The above and other objects and advantages of the present invention will become more apparent from the following description taken in conjunction with the following drawings in which:

FIG. 1 is a side view illustrating an exemplary multi-medium vehicle system common controller coupled to a ground vehicle in a first position;

FIG. 2 is a side view illustrating an exemplary embodiment of the multi-medium vehicle system common controller of FIG. 1 coupled to a ground vehicle in a second position;

FIG. 3 is a side view illustrating an exemplary embodiment of the multi-medium vehicle system common controller of FIG. 1 coupled to a ground vehicle with a payload in an operational position;

FIG. 4 is a front view illustrating an exemplary embodiment of the multi-medium vehicle system common controller of FIG. 1 coupled to a ground vehicle;

FIG. 5 is a side view illustrating an exemplary embodiment of the multi-medium vehicle system common controller of FIG. 1 coupled to a ground vehicle and with hybrid pontoons in three positions;

FIG. 6 is a side view illustrating an exemplary embodiment of the multi-medium vehicle system common controller of FIG. 1 coupled to a water craft and with hybrid pontoons in an operational position;

FIG. 7 is an end view illustrating an exemplary embodiment of the multi-medium vehicle system common controller of FIG. 1 flexibly coupled to a ground vehicle and to twin airship hulls;

FIG. 8 is a side view illustrating an exemplary embodiment of the multi-medium vehicle system common controller of FIG. 1 coupled to a ground vehicle with hybrid pontoons in an initial position for climbing an obstacle;

FIG. 9 is a side view illustrating an exemplary embodiment of the multi-medium vehicle system common controller of FIG. 1 coupled to a ground vehicle with hybrid pontoons in an intermediate position for climbing an obstacle;

FIG. 10 is a side view illustrating an explorer carrying an exemplary embodiment of the multi-medium vehicle system common controller of FIG. 1 coupled to a ground vehicle;

FIG. 11 is a side view illustrating the exemplary embodiment of the multi-medium vehicle system common controller of FIG. 1 coupled to at least one hull of a twin-hulled airship partially within an ISO storage container;

FIG. 12 is a side view illustrating an airship hull that is segmented for storage in an ISO container and can be assembled for flight;

FIG. 13 is a perspective view illustrating an exemplary embodiment of the multi-medium vehicle system common controller coupled to an inflatable boat;

FIG. 14 is a side elevation view illustrating an exemplary embodiment of the multi-medium vehicle system common controller coupled to a speedboat;

FIG. 15 is a side elevation view illustrating an exemplary embodiment of the multi-medium vehicle system common controller coupled to an all-terrain vehicle;

FIG. 16 is a diagram illustrating an exemplary sequence of operational steps in the use of an exemplary multi-medium vehicle system.

FIG. 17 is a side elevation view illustrating an exemplary embodiment of the multi-medium vehicle system common controller coupled to a ground vehicle and carrying a payload of rockets.

### DETAILED DESCRIPTION OF THE DRAWINGS

The following detailed description is merely exemplary in nature and is not intended to limit the invention or the application and uses of the invention. Furthermore, there is no intention to be bound by any expressed or implied theory presented in the preceding technical field, background, brief summary or the following detailed description. The numerous examples provided are illustrative and are not intended to be limiting.

Turning now to FIG. 1, salient features of an exemplary embodiment of common controller 100 of an exemplary multi-medium vehicle system is illustrated coupled to a motorized ground vehicle (shown as a toy remote control tank) 102 with flexible couplings 103 and 105. Flexible couplings 103 and 105 may be releasable couplings. A toy remote control tank was selected as the ground vehicle 102 for building the original brass board model because of its useful remote control features. While control is calculated in the common controller 100, actuators for implementing ground vehicle 102 controls remain in the ground vehicle 102. Thus the control system is distributed, or shared, between the common controller 100 and the ground vehicle 102. The ground vehicle 102 may have tracks 108, as shown. The ground vehicle 102 has a turret 104 that rotates about a vertical axis and a strut 106 that rotates about a horizontal axis. Flexible coupling 103 couples common controller 100 to strut 106 and flexible coupling 105 couples common controller 100 to turret 104, enabling controlled attitudinal motion of the common controller 100 relative to the ground vehicle 102. Those skilled in the art, upon reading the teachings of this specification, will appreciate that, under appropriate circumstances, considering such issues as mission requirements, particular vehicle designs, and weight limits, other designs of common controller 100, such as those adapted to other types of vehicles, other attitude control implementations, and different control-sharing strategies, etc., may be used with the multi-medium vehicle system.

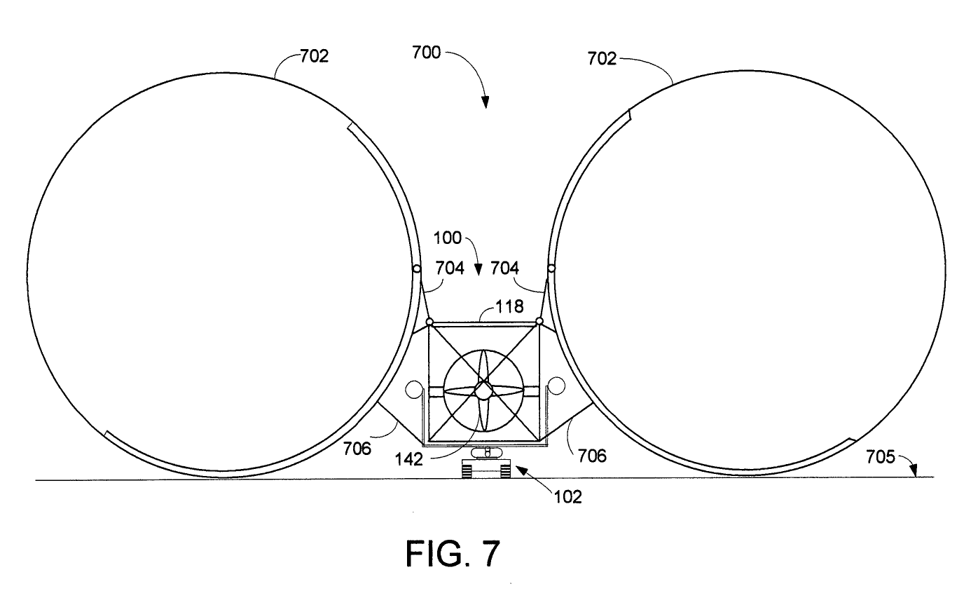

Common controller 100 has a structure 118, shown as a box truss frame with struts 120 in FIG. 1. The structure 118 is adapted to receive twin airship hulls 702 (FIG. 7) to enable flight. Structure 118 may include payload gondola 124. Payload gondola 124 is operable to position the payload 121 for employment relative to the ground vehicle 102 and common controller 100. The structure 118 is mechanically coupled to an electronic control module 110 that assists in communications, navigation, and control for the common controller 100, the airship 700 (FIG. 7), and for the ground vehicle 102. Electronic control module 110 is electronically coupled to ground vehicle 102 at least during ground operations. Control signals received by electronic control module 110 may be processed into servo commands to rotate the turret 104, raise or lower the strut 106, and move track 108 to propel the ground vehicle 102. Electronic control module 110 may also produce signals to operate servomechanisms coupled to the common controller 100. For example, a servomechanism to raise or lower gondola 124 or servomechanisms for vectoring the thrust of propellers 142 may receive commands from electronic control module 110. Those skilled in the art, upon reading the teachings of this specification, will appreciate that, under appropriate circumstances, considering such issues as mission requirements, particular vehicle designs, and control technology, other designs of common controller 100, such as those adapted to other types of vehicles, other electronic control module implementations, and, various control couplings, etc., may be used with the multi-medium vehicle system.

Electronic control module 110 may be adapted to assist in control of at least one other vehicle. For example, electronic control module 110 assists in controlling the aerial flight of the airship 700 (FIG. 7) when airship hulls 702 (FIG. 7) are coupled to structure 118. Common controller 100 may have features beyond those needed for coupling and ground vehicle control. In FIG. 1, structure 118 is shown with a payload gondola 124, which is controllable in vertical movement via signals from electronic control module 110. Payload gondola 124 may support a payload 121, such as operational collimated sensor 112 having laser pointer 114 and video camera 130, each of which may be controlled using the assistance of electronic control module 110. In other embodiments, payload 121 may be of various types. For example, payload 121 may include surveillance apparatus, environmental monitoring apparatus, weapons, and/or communications apparatus. Those skilled in the art, upon reading the teachings of this specification, will appreciate that, under appropriate circumstances, considering such issues as mission requirements, particular sensor designs, and particular actuator designs, other designs of common controller 100, such as those adapted to other types of missions, other sensor suites, and various data transfer approaches, etc., may be used with the multi-medium vehicle system.

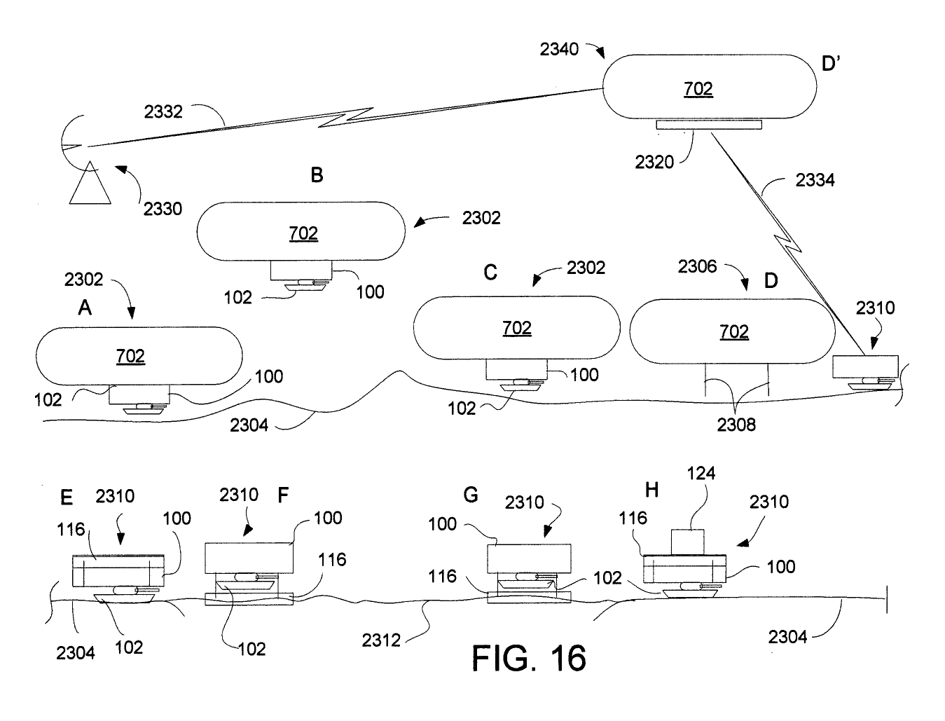

Electronic control module 110 may be configured to receive and process remote control signals from a remote control console 2330 (FIG. 16) operated by a user. In an alternate embodiment, command sequences may be stored in a memory associated with the electronic control module 110 and may be executed by remote or local command. Electronic control module 110 may be configured to receive data from sensors that are included in the electronic control module 110, coupled to the common controller 100, or coupled to any vehicle coupled to common controller 100 and to store and send that data to a remote user. For example, electronic control module 110 may store, use and send data from a Global Positioning System receiver that is part of the electronic control module 110. For further example, electronic control module 110 may store and send video data from video camera 130. For yet another example, electronic control module 110 may store and send data from a fuel sensor onboard a coupled vehicle, such as ground vehicle 102. These examples are merely illustrative, and are not intended to be limiting. Those skilled in the art, upon reading the teachings of this specification, will appreciate that, under appropriate circumstances, considering such issues as mission objectives, mission durations, and operational environments, other designs of electronic control module 110, such as those adapted to other types of navigation, communications, and data collection, etc., may be used with the multi-medium vehicle system.

Electronic control module 110 may include a navigator. In the embodiment illustrated in FIG. 1, the navigator comprises a navigation computer in electronic control module 110 and coupled to a video link to the user and a command link from the user to the electronic control module 110 of the common controller 100. In a particular embodiment, the navigator comprises an autonomous navigation system, as are known in the art of avionics, and may store and execute navigation instructions. In yet another embodiment, the navigator comprises common manual controls for a human operator who rides in the ground vehicle 102, navigates by sight and inputs appropriate course corrections manually. For example, consider an embodiment coupling an airboat (also known as a swamp boat) with a twin-hull airship via a common controller 100. An operator may ride in the coupled swamp boat and may control airship operation through interpretations of the swamp boat's manual operator control outputs made by the electronic control module 110. When the swamp boat uncouples to operate over water, control outputs from the swamp boat's manual operator controls automatically switch to controlling the swamp boat. Those skilled in the art, upon reading the teachings of this specification, will appreciate that, under appropriate circumstances, considering such issues as mission objectives, mission durations, and operational environments, other navigation approaches, such as hybrids of autonomous navigation and remote control, artificially intelligent navigators, and target-responsive navigation, etc., may be used with the multi-medium vehicle system.

Communications links between electronic control module 110 and the remote control console 2330 (FIG. 16) may be as simple as those provided by commercial-off-the-shelf (COTS) radio remote control units or as complex as encrypted and protected satellite communications. Electronic control module 110 comprises a local communicator, or transceiver, for communicating with a remote communicator associated with the remote control console 2330. In a preferred embodiment for short-range (approximately 0.25 miles), a 16-channel COTS remote control unit may be provided, with a separate wireless link between the video camera 130 and a personal computer. The personal computer may be integral to the remote control console 2330. In another preferred embodiment, the physical configuration of electronic control module 110 coupled to structure 118 comprises a personal computer motherboard and at least one universal serial bus (USB) connection to at least one USB actuator coupled to the common controller 100. Those skilled in the art, upon reading the teachings of this specification, will appreciate that, under appropriate circumstances, considering such issues as vehicle size and complexity, payload control requirements, and operational requirments, other designs of electronic control module 110, such as those adapted to combined payload and vehicle control, distributed control, adaptive control, and redundant control, etc., may be used with the multi-medium vehicle system.

Common controller 100 may have features related to assisting in propulsion of one or more vehicles. For example, hybrid pontoon 116, flexibly coupled to structure 118 as a four-bar mechanism using rotatable struts 122 may assist in amphibious operation of the ground vehicle 102 or in surmounting land obstacles, as will be discussed in more detail below. For further example, motors 140 and aerial propellers 142 may be used to propel the common controller 100 and ground vehicle 102 during aerial operations when twin airship hulls 702 (FIG. 7) are flexibly coupled to structure 118. With the twin airship hulls detached, motors 140 and aerial propellers 142 may assist in propelling the combination of the common controller 100 and the ground vehicle 102 over water using the hybrid pontoons 116. Accordingly, the common controller 100 with the ground vehicle 102 and airship hulls 702 (FIG. 7) coupled thereto (a multi-medium vehicle) may be flown as an airship to a first location, the airship hulls 702 may be detached to proceed over land, and then the combined common controller 100 and ground vehicle 102 may proceed across water on hybrid pontoons 116 as a pontoon boat propelled by motors 140 and propellers 142 as will be discussed in more detail below. Those skilled in the art, upon reading the teachings of this specification, will appreciate that, under appropriate circumstances, considering such issues as propulsion requirements, transportation mediums, and fuel economy, other designs of common controller 100, such as those adapted to other types of propulsion, use of multiple propulsion options for various flight regimes, and redundant propulsion systems, etc., may be used with the multi-medium vehicle system.

Common controller 100 may further include an intelligent navigation assistant, such as those known in the art of Mars rovers, which enables obstacle avoidance and determination of a preferred path through difficult terrain. The intelligent navigation assistant is preferably integrated into the electronic control module 110. The intelligent navigation assistant is preferably autonomously operable to scan terrain and choose a navigable path to a selected destination. The intelligent navigation assistant is preferably operable to scan terrain from each transportation medium for which a particular multi-medium vehicle system is designed. For example, an intelligent navigation assistant may be able to scan terrain from an aerial platform. Those skilled in the art, upon reading the teachings of this specification, will appreciate that, under appropriate circumstances, considering such issues as mission objectives, mission durations, and operational environments, other approaches to ground navigation, such as employing geographic information systems, real-time map updating, and artificial intelligence, etc., may be used with the multi-medium vehicle system.

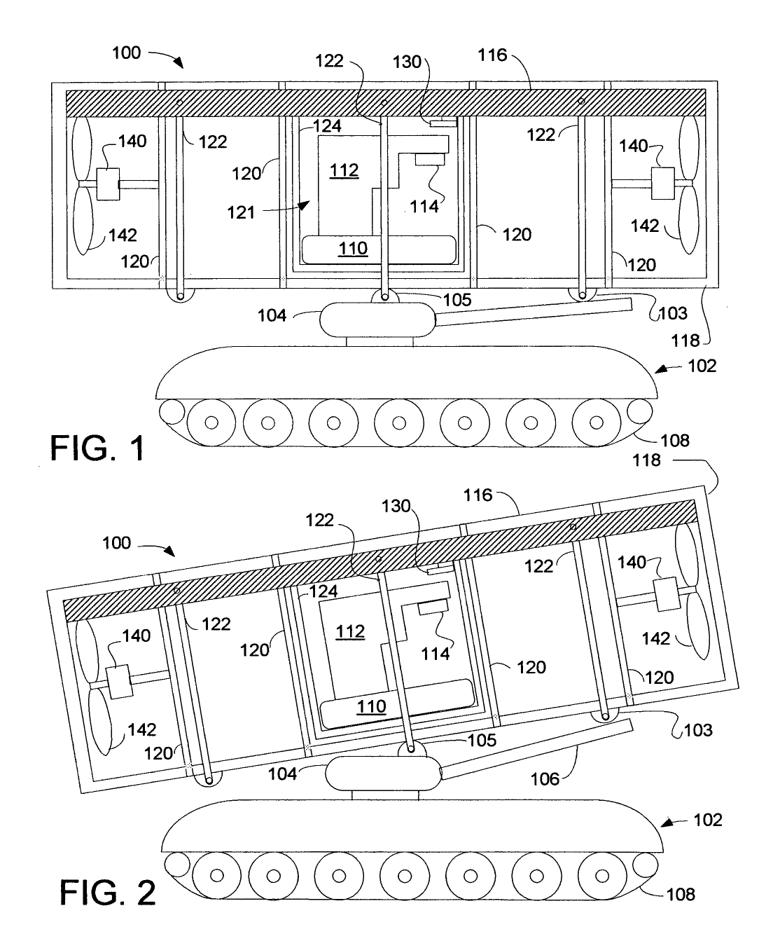

FIG. 2 is a side view illustrating an exemplary embodiment of the multi-medium vehicle system common controller 100 of FIG. 1 coupled to a ground vehicle 102 in a second position. Strut 106 is shown raised to a second position to tilt the structure 118 of the common controller 100 relative to the ground vehicle 102. Hybrid pontoon 116 is shown in the stowed, upper position. Attitude control of the common controller 100 may be by remote control or may be automatic. For example, the attitude of the common controller 100 may be automatically controlled to remain level as the ground vehicle encounters uneven terrain. For another example, the attitude of the common controller 100 may be remotely controlled to assist in pointing operational collimated sensor 112 using laser target designator 114 and video camera 130. Those skilled in the art, upon reading the teachings of this specification, will appreciate that, under appropriate circumstances, considering such issues as mission objectives, mission durations, and operational environments, other useful elements may be added to common controller 100, such as sensors, weapons, and actuators, etc., may be used with the multi-medium vehicle system.

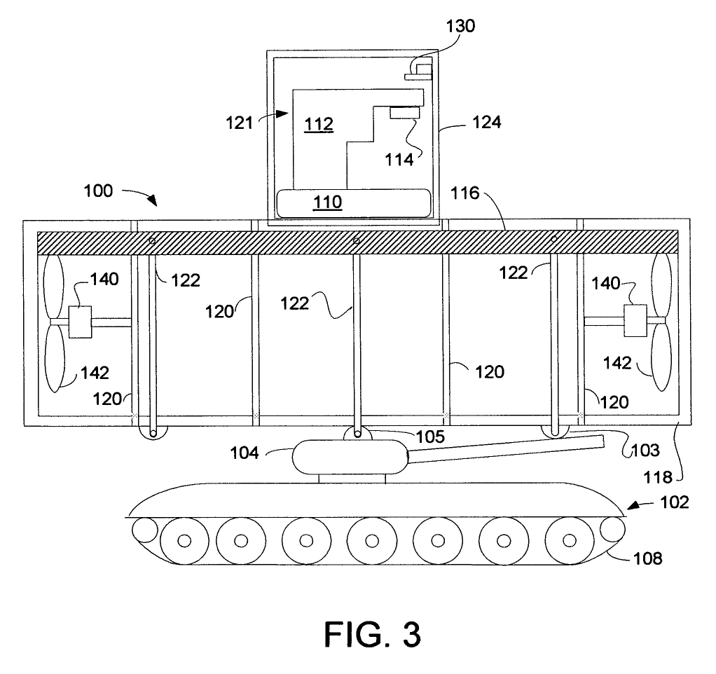

FIG. 3 is a side view illustrating an exemplary embodiment of the multi-medium vehicle system common controller 100 of FIG. 1 coupled to a ground vehicle 102 with a payload 121 in a raised operational position. Payload gondola 124 may be extended upward to employ the payload 121 in response to signals from the electronic control module 110. Electronic control module 110 is shown mechanically coupled to the payload gondola 124 of structure 118. In a particular embodiment, the electronic control module 110 may be mechanically coupled to the structure 118 and not to the payload gondola 124. In yet another particular embodiment, electronic control module 110 may be distributed between the payload gondola 124 and the remainder of structure 118. Those skilled in the art, upon reading the teachings of this specification, will appreciate that, under appropriate circumstances, considering such issues as vehicle design, common controller size and weight limitations, and operational environments, other designs of relationship between common controller 100 and electronic control module 110, such as smart skin technology, cross-strapped redundant modules, and articulation means other than a gondola, etc., may be used with the multi-medium vehicle system.

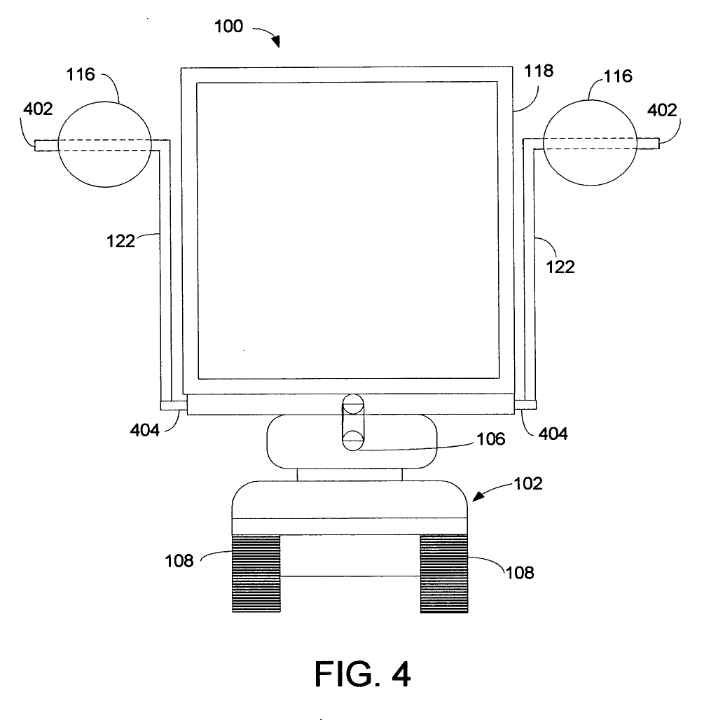

FIG. 4 is a front view illustrating an exemplary embodiment of the multi-medium vehicle system common controller 100 of FIG. 1 coupled to a ground vehicle 102. Hybrid pontoons 116 are rotationally mounted on axles 402 extending from four-bar mechanism struts 122. A drive motor, controlled with the assistance of electronics control module 110, may rotate drive axle 404 to move the hybrid pontoons 116 to a lower, operational position. Preferably, the drive uses a worm gear. The length of four-bar mechanism struts 122 and the location of drive axle 404 are preferably selected to enable the ground vehicle 102 to stay substantially out of the water during aquatic operations and to enable obstacle climbing during terrestrial operations. In a particular embodiment, struts 122 may be of variable length. Those skilled in the art, upon reading the teachings of this specification, will appreciate that, under appropriate circumstances, considering such issues as mission objectives, mission durations, and operational environments, other designs of hybrid pontoons, such as those adapted to other types of fluids, those adapted to climbing particular types of obstacles, and variable-geometry hybrid pontoons, etc., may be used with the multi-medium vehicle system.

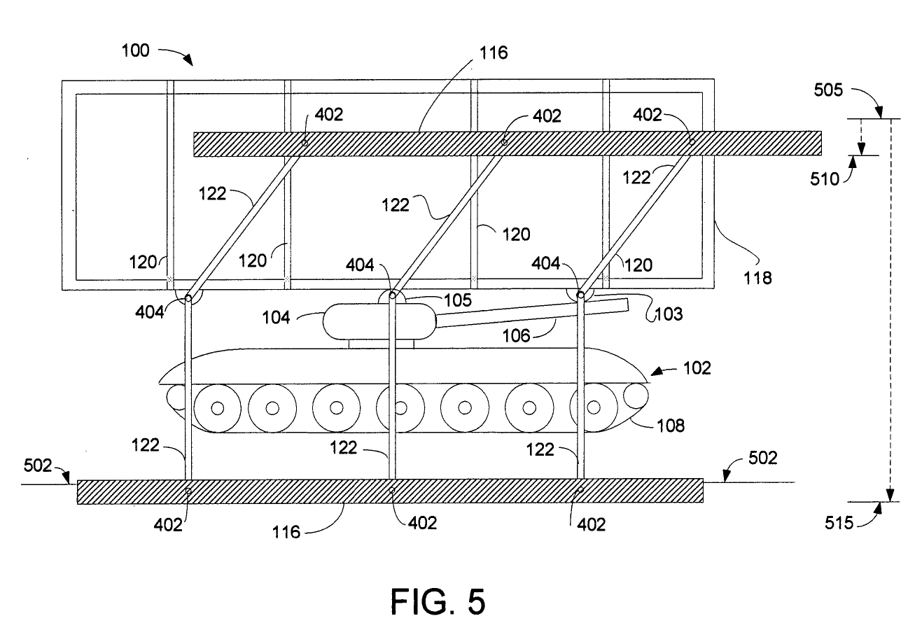

FIG. 5 is a side view illustrating an exemplary embodiment of the multi-medium vehicle system common controller 100 of FIG. 1 coupled to a ground vehicle 102 and illustrating hybrid pontoons 116 in two positions. For aquatic operations, the hybrid pontoons 116 may be lowered by a 180-degree rotation of drive axles 404. The upper position 505 of the hybrid pontoons 116 is a stowed, or non-operational position. The lowest position 515 may be used in aquatic operations on water 502. The intermediate position 510 suggests the motion of the four-bar mechanism that includes structure 118, four-bar mechanism struts 122, and the hybrid pontoon 116. The position of hybrid pontoons 116 is controlled with the assistance of electronic control module 110. Propulsion over water may be provided by the aerial propellers 142 (FIG. 1) coupled to the structure 118 and controlled with the assistance of the electronic control module 110. Steering may be provided using the vectored thrust aerial propellers 142 (FIG. 1) flexibly and controllably coupled to the structure 118 and controlled with the assistance of the electronic control module 110. Those skilled in the art, upon reading the teachings of this specification, will appreciate that, under appropriate circumstances, considering such issues as mission objectives, vehicle design, and operational environments, other approaches to moving the hybrid pontoons 116 into operational positions, such as hydraulic struts, rack and pinion elevators, or pivot joints etc., may be used with the multi-medium vehicle system.

For the embodiment shown, hybrid pontoons 116 may comprise closed-cell polymer foam tubing as are known in the art of swimming pool toys. A rigid shaft, preferably of buoyant material such as wood, may be tightly inserted axially through each foam tube and the tube and shaft transversely drilled to receive axles 402. In particular embodiments, the surface of the foam tubes may have a more hydrodynamic shape. The surface of the pontoons 116 has frictional characteristics that assist in climbing obstacles. Higher-friction surface material may be applied to the hybrid pontoons 116 in various embodiments. Those skilled in the art, upon reading the teachings of this specification, will appreciate that, under appropriate circumstances, considering such issues as types of obstacles to be overcome, material properties, and operational environments, other surface treatments for hybrid pontoons 116, such as spikes on the underside of the hybrid pontoons 116, releasable adhesives, flexible fingers, etc., may be used with the multi-medium vehicle system.

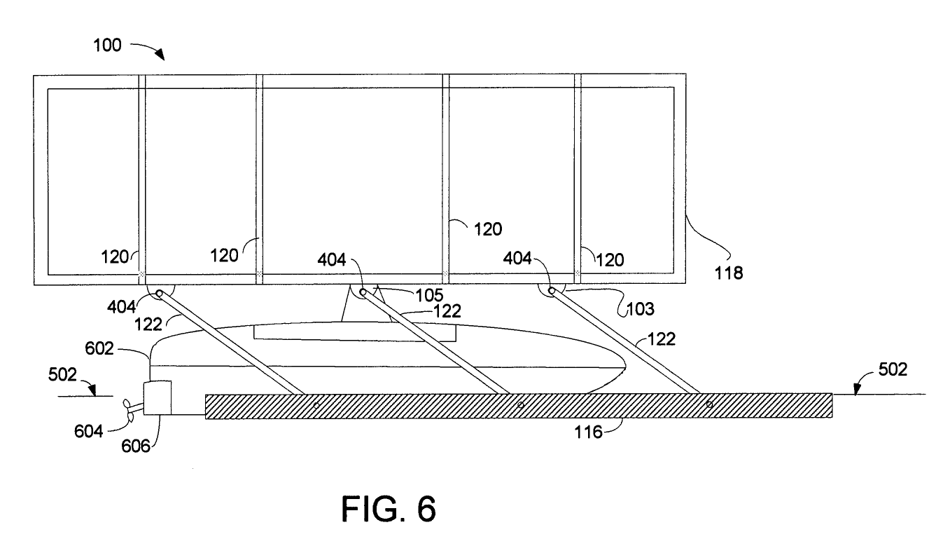

FIG. 6 is a side view illustrating an exemplary embodiment of the multi-medium vehicle system common controller 110 of FIG. 1 coupled to a watercraft 602 and with hybrid pontoons 116 in an operational position. Drive axles 404 are preferably lockable at any angle of rotation. For higher-speed aquatic operations, a specialized watercraft 602 is preferably used in conjunction with hybrid pontoons 116 to form a trimaran aquatic hull. Motorized watercraft 602 uses aquatic propeller 604 for propulsion, optionally in conjunction with the aerial propellers 142 (FIG. 1) of the common controller 100 and controlled with the assistance of the electronic control module 110 (FIG. 1). Motorized watercraft 602 may be steered using a rudder 606 of watercraft 602, optionally in conjunction with the vectored thrust aerial propellers 142 (FIG. 1) flexibly and controllably coupled to the structure 118 and controlled with the assistance of the electronic control module 110. Those skilled in the art, upon reading the teachings of this specification, will appreciate that, under appropriate circumstances, considering such issues as mission objectives, mission durations, and operational environments, other types of watercraft, such as catamarans, jet ski vehicles, submarines, etc., may be used with the multi-medium vehicle system.

FIG. 7 is an end view illustrating an exemplary embodiment of the multi-medium vehicle system common controller 100 of FIG. 1 flexibly coupled to a ground vehicle 102 and to twin airship hulls 702. The twin-hulled airship 700 is shown in a 3-point landing configuration. Airship 700 is representative of atmospherically buoyant vehicles and does not imply limitations of flight in air: uses for planetary exploration are anticipated. More generally, airship 700 is representative of atmospheric vehicles capable of landing velocities that have with low horizontal components. For example, helicopters and vertical take-off and landing aircraft have low horizontal components of landing velocity. Struts 704 are flexibly coupled to structure 118 of common controller 100. Cables 706 are adjustable in length to control, as assisted by electronic control module 110, the positions of the twin airship hulls 702 relative to the common controller 100. In some embodiments, cables 706 may be variable-length struts 706. In a preferred embodiment, the twin airship hulls 702 may be detached by hand. In another particular embodiment, the twin airship hulls 702 may be anchored to the ground responsive to control signals from the electronic control module 110. The anchors may be of a grasping type that hold fast to terrain features, a deployable fabric sea-anchor for holding the airship 100 on the surface of the water, augers for penetrating the surface of the ground, or methods of similar functionality. After the twin airship hulls 702 are anchored to the ground, the common controller 100 may uncouple from the twin airship hulls 702 and proceed terrestrially to perform its mission using the ground vehicle 102. After the terrestrial mission is complete, the common controller 110 and ground vehicle 102 may return to re-couple with the twin airship hulls 702, release the anchors, and return to the user by flight. Those skilled in the art, upon reading the teachings of this specification, will appreciate that, under appropriate circumstances, considering such issues as mission objectives, vehicle types, and vehicle designs, other approaches for securing a vehicle detached from the common controller 100, such as parking, hovering, submerging, adhering, etc., may be used with the multi-medium vehicle system.

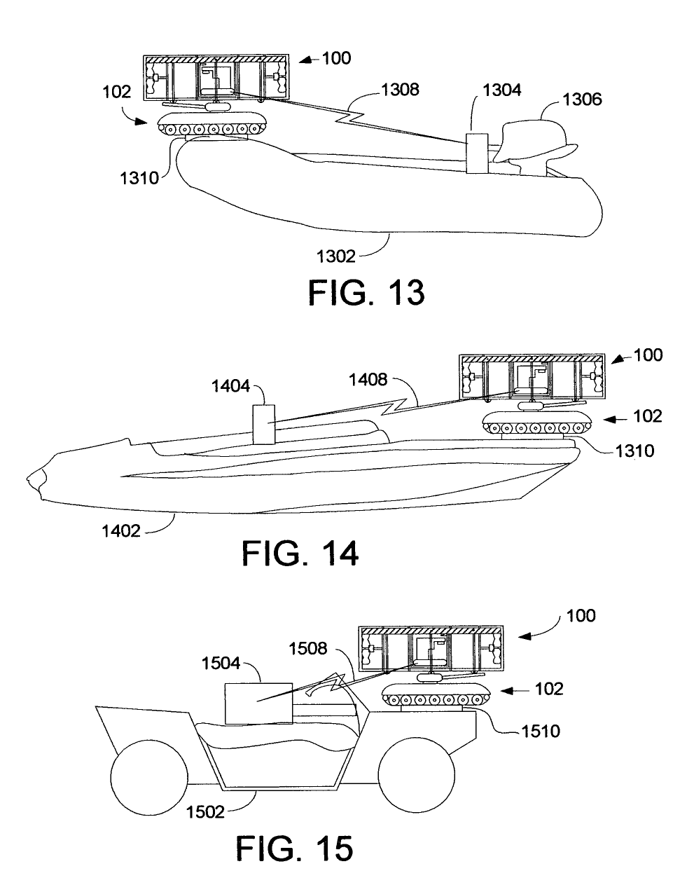

In alternate embodiments, other types of aircraft may be used, such as helicopters, single-hull airships, and winged aircraft with vertical takeoff and landing capability. In still other embodiments, vehicles that are not aircraft may be used. For example, a boat may be coupled to a common controller 100 that is coupled to a ground vehicle (FIG. 13 and FIG. 14). For further example, a common controller 100 may be coupled to a spacecraft, a reentry vehicle, a parachute, an airship, and an amphibious vehicle that operate in sequence, each at least assisted by the common controller 100. Those of skill in the art who have read this disclosure will now appreciate that various transportation mediums may be made of the same material but require different customized vehicles. For example, the sea may require different vehicles depending upon what depth (surface, sub-surface, bathyspheric) is to be navigated. Similarly, those of skill in the art who have read this disclosure will now appreciate that atmospheres and surfaces of celestial objects other than Earth's may require specialized vehicles coupled to a common controller 100. Those skilled in the art, upon reading the teachings of this specification, will appreciate that, under appropriate circumstances, considering such issues as mission objectives, mission durations, and operational environments, other combinations of vehicles with a common controller 100, such as an airship-swamp boat-submersible vehicle combination, a sled-ATV-boat vehicle combination, a ship-launch booster-satellite vehicle combination, etc., may be used with the multi-medium vehicle system.

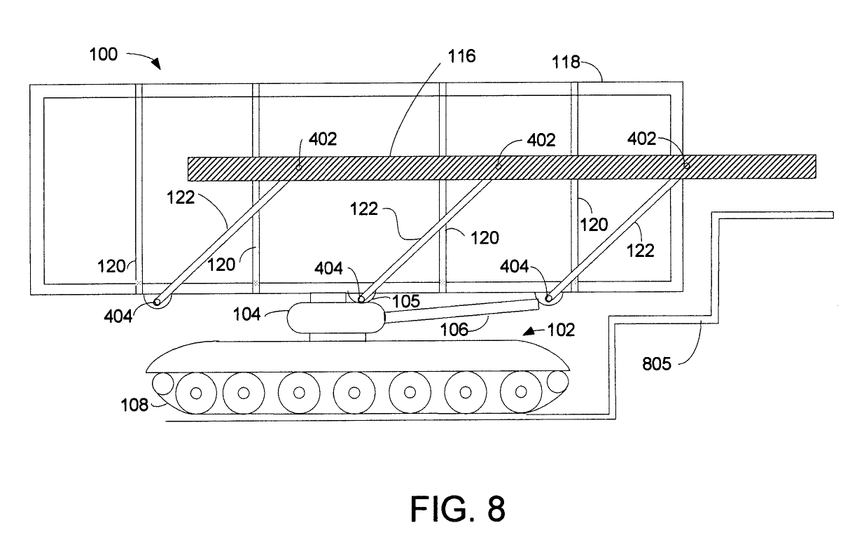

FIG. 8 is a side view illustrating an exemplary embodiment of the multi-medium vehicle system common controller 100 of FIG. 1 coupled to a ground vehicle 102 with hybrid pontoons 116 in an initial position for climbing an obstacle 805. Hybrid pontoon 116 is positioned forward and downward of the stowed position 505 in preparation for engaging obstacle 805, illustrated as stairs. The hybrid pontoon 116 is part of a four-bar mechanism comprising structure 118, four-bar mechanism struts 122, and hybrid pontoon 116. Motion of the hybrid pontoon 116 may be controlled with assistance from the electronic control module 110 (FIG. 1). Those skilled in the art, upon reading the teachings of this specification, will appreciate that, under appropriate circumstances, considering such issues as type of obstacle, mission requirements, and operational environments, other approaches to obstacle climbing, such as those using dedicated climbing means, multiple selectable climbing means, etc., may be used with the multi-medium vehicle system.

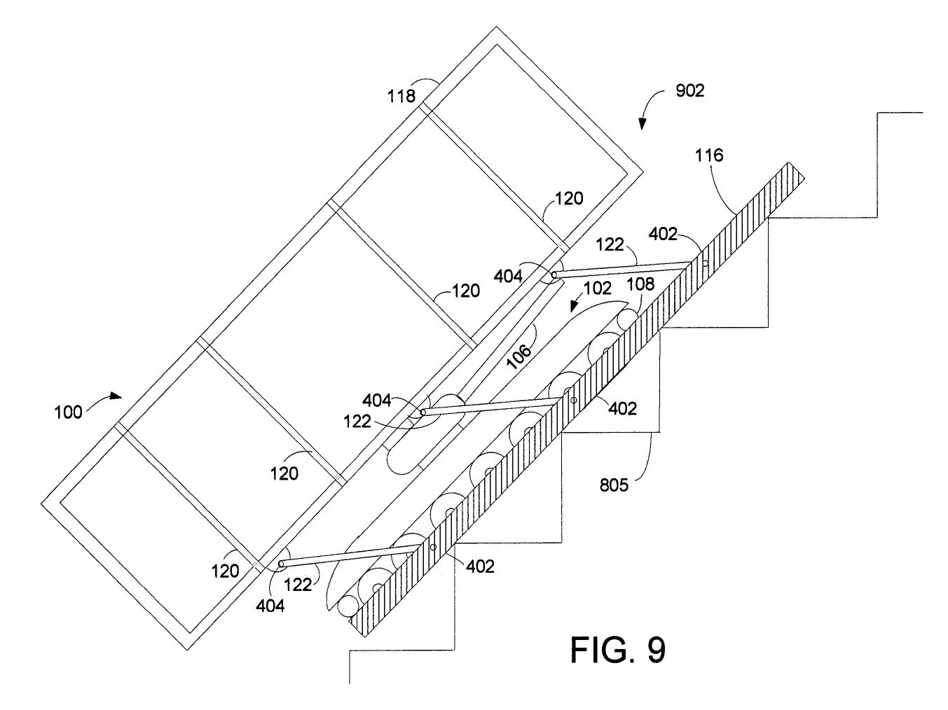

FIG. 9 is a side view illustrating an exemplary embodiment of the multi-medium vehicle system common controller 100 of FIG. 1 coupled to a ground vehicle 102 with hybrid pontoons 116 in an intermediate position for climbing an obstacle 805. Hybrid pontoons 116 and the track 108 of the ground vehicle 102 are illustrated engaging the obstacle 805 simultaneously. As the four-bar mechanism 902 (collectively 116, 118, 122) drives, ground vehicle 102 and common controller 100 will be lifted off the obstacle 805 and moved upward and forward. The track 108 will again come into contact with the surface of the obstacle 802 to hold the ground vehicle 102 and the common controller 100 in place while the four-bar mechanism 902 completes its rotation to re-engage the obstacle and lift the ground vehicle 102 and the common controller 100 to a higher point on the obstacle 805. Those skilled in the art, upon reading the teachings of this specification, will appreciate that, under appropriate circumstances, considering such issues as mission objectives, mission durations, and operational environments, other designs of the four-bar mechanism, such as those using variable-length struts, multiple hybrid pontoon 116 sections, etc., may be used with the multi-medium vehicle system.

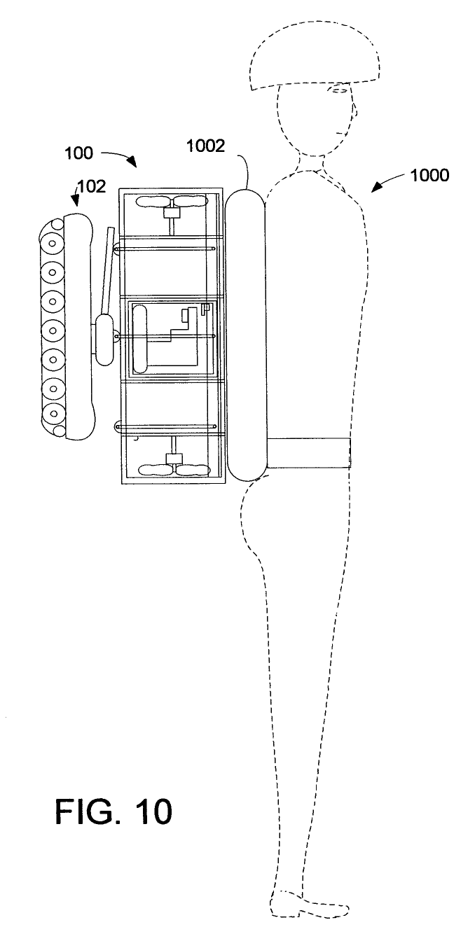

FIG. 10 is a side view illustrating an explorer 1000 carrying an exemplary embodiment of the multi-medium vehicle system common controller 100 of FIG. 1 coupled to a ground vehicle 102 on a backpack 1002. Twin airship hulls 702 (FIG. 7) may be transported separately. Embodiments of the common controller 100 and ground vehicle 102 may be of any producible size, from micro-electro mechanical systems (MEMS) to embodiments supporting multi-ton ground vehicles 102. The embodiment illustrated in FIG. 10 is preferred for supporting exploratory operations with surveillance and communications. The size relationship between the common controller 100 and the ground vehicle 102 may vary greatly. In particular embodiments, for example, the common controller 100 may have only communications, navigation, and control assistance functions and may be incorporated in a personal data assistant (PDA) or personal computer (PC). Likewise, the ground vehicle 102 may be much larger than the common controller 100. For example, the ground vehicle 102 may be a dune buggy operated by remote control to extract a stranded hiker, and the common controller 100 may comprise a PC capable of assisting with operating both the twin-hull airship 700 (FIG. 7) and the dune buggy. Those skilled in the art, upon reading the teachings of this specification, will appreciate that, under appropriate circumstances, considering such issues as mission objectives, mission durations, and operational environments, other designs of common controller 100, such as a single custom microchip, programmable logic, fluidic logic, etc., may be used with the multi-medium vehicle system.

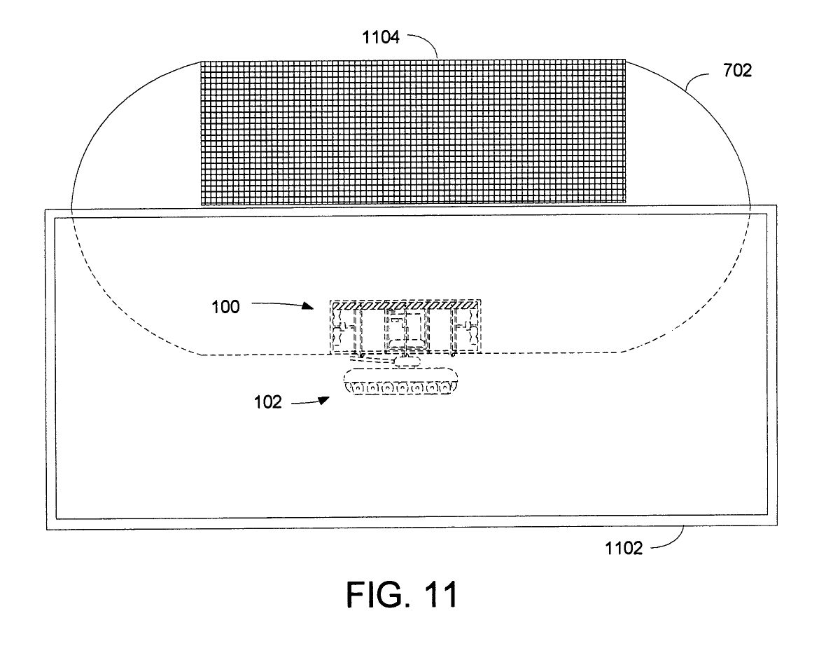

FIG. 11 is a side view illustrating the exemplary embodiment of the multi-medium vehicle system common controller 100 and ground vehicle 102 coupled to at least one hull 702 of a twin-hulled airship partially within an ISO storage container 1102. The hull 702 comprises a top-mounted thin-film solar photovoltaic array 1104 which may be used during operations to supply power to the motors 140 (FIG. 1), the electronic control module 110 (FIG. 1), and associated control servos and sensors. In storage, the airship hull 702 may be stored in an ISO container 1102 or partially raised through the top of the ISO container 1102, as shown, to produce electrical power for ground operations under the control of the common controller 100. FIG. 11 illustrates the concept of alternate uses for variable-configuration vehicles using their coupling to a common controller 110. Those skilled in the art, upon reading the teachings of this specification, will appreciate that, under appropriate circumstances, considering such issues as mission objectives, mission durations, and operational environments, other storage and transport options for multi-medium vehicle systems, such as that integral to one of the vehicles, customized storage or transport containers, etc., may be used with the multi-medium vehicle system.

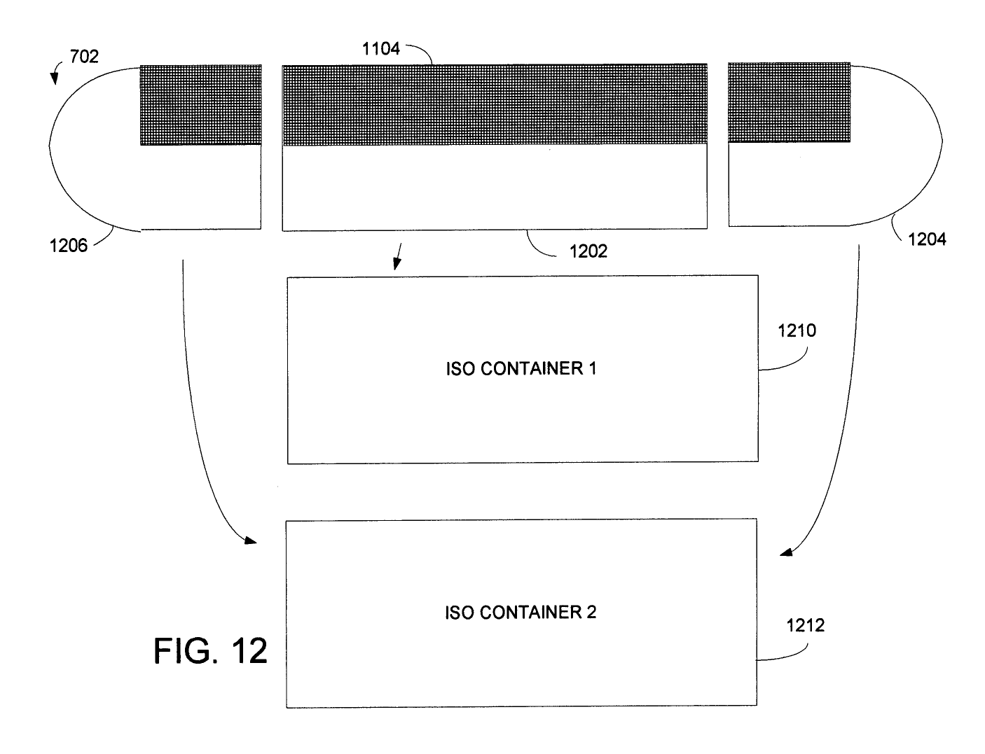

FIG. 12 is a side view illustrating an airship hull 702 that is segmented for storage in an ISO container 1102 and can be assembled for flight. End segments 1206 and 1204 may be mated directly together or to opposite ends of middle segment 1202, as shown. The end segments 1206 and 1204 may be stored in an ISO container 1212 having a nominal length of 20 feet and a nominal width of eight feet. Middle segment 1202 may be stored in another ISO container 1210 of similar dimensions. The round hull 702 in the square ISO container leaves corner room for ancillary equipment used with the multi-medium vehicle system and/or that may powered by the solar photovoltaic array 1104. For examples, ancillary equipment may include battery chargers, hydrolysers for producing hydrogen from water, and water purification equipment. FIG. 12 also illustrates the concept of variable-configuration vehicles and their storage and transport. A variable-configuration vehicle has a set of parts which may be put together in various ways. Those skilled in the art, upon reading the teachings of this specification, will appreciate that, under appropriate circumstances, considering such issues as vehicle design, transportation environments, and economy, other ways of segmenting vehicles for storage and transport, such as partial disassembly, modularity of vehicle design, and interchangeable sections of various vehicles, etc., may be used with the multi-medium vehicle system.

FIG. 13 is a perspective view illustrating an exemplary embodiment of the multi-medium vehicle system common controller 100 coupled to a ground vehicle 102 and carried by an inflatable boat 1302. Mechanical interface 1310 provides a mechanical coupling between the ground vehicle 102 and the boat 1302, and preferably provides a launching mechanism. The common controller 100 and the ground vehicle 102 may be launched onto shore or water from the inflatable boat 1302. The inflatable boat 1302 may have a local actuator assembly 1304 to enable electronic control of the motor 1306 and steering. The common controller 100 preferably has control couplings 1308, which may be wireless, directly to the local actuator assembly 1304. Common controller 100 has couplings to inflatable boat 1302 and to the ground vehicle 102 to assist in controlling each vehicle 1302 and 102. In a particular embodiment in which the vehicle is itself normally controlled electronically, control couplings 1308 may include a data link to the vehicle control system's input registers. Those skilled in the art, upon reading the teachings of this specification, will appreciate that, under appropriate circumstances, considering such issues as vehicle design, operational environment, and economy, other ways of linking the common controller 100 to the control system of the boat, such as hard-wiring, optical data links, etc., may be used with the multi-medium vehicle system.

FIG. 14 is a side elevation view illustrating an exemplary embodiment of the multi-medium vehicle system common controller 100 coupled to a ground vehicle 102 and carried by a speedboat 1402. Mechanical interface 1410 provides a mechanical coupling between the ground vehicle 102 and the speedboat 1402, and preferably provides a launching mechanism. The common controller 100 and the ground vehicle 102 may be launched onto shore or water from the speedboat 1402. The speedboat 1402 may have a local actuator assembly 1404 to enable electronic control of the motor and steering. The common controller 100 preferably has control couplings 1408, which may be wireless, directly to the local actuator assembly 1404. The speedboat 1402 has an electronically controllable motor and steering, the common controller 100 preferably has control couplings directly to the speedboat 1402 and to the ground vehicle 102 and may assist in controlling both. Those skilled in the art, upon reading the teachings of this specification, will appreciate that, under appropriate circumstances, considering such issues as vehicle design, transportation environments, and economy, various local actuator assemblies, such as hydraulic, electro-mechanical, fluidic, electromagnetic, etc., may be used with the multi-medium vehicle system.

FIG. 15 is a perspective view illustrating an exemplary embodiment of the multi-medium vehicle system common controller 100 coupled to a ground vehicle 102 and to an all-terrain vehicle (ATV) 1502. The common controller 100 and the ground vehicle 102 may be launched off shore or onto land from the ATV 1502. The ATV 1502 preferably has an electronically controllable motor and steering. The ATV 1502 preferably has a local actuator assembly 1504 to enable electronic control of the motor and steering. The common controller 100 preferably has control couplings 1508, which may be wireless, directly to the ATV 1502 and to the ground vehicle 102 and may assist in controlling each vehicle 1502 and 102. Those skilled in the art, upon reading the teachings of this specification, will appreciate that, under appropriate circumstances, considering such issues as vehicle design, transportation environments, and economy, various approaches to controlling local actuator assemblies, such as interception, spoofing, overriding, etc., may be used with the multi-medium vehicle system.

FIG. 23 is a diagram illustrating an exemplary sequence of operational steps in the use of an exemplary multi-medium vehicle system. Step “A” illustrates a multi-medium vehicle 2302 assembled on terrain 2304 proximate a remote control console 2330 by coupling twin airship hulls 702 to common controller 100 that is further coupled to ground vehicle 702. Step “B” illustrates multi-medium vehicle 2302 launched from terrain 2304 and in flight under the control of the common controller 100. Step “C” illustrates multi-medium vehicle 2302 landed upon terrain 2304, under the control of the common controller 100, at a different location. Step “D” illustrates twin airship hulls 702 anchored to the terrain 2304 by anchors 2308 and further illustrates vehicle 2310, comprising the common controller 100 and ground vehicle 102, uncoupled from twin airship hulls 702 and moving along the terrain under the control of the common controller 100. In an alternate embodiment shown as step “D”, twin-hulled airship 2340 has residual control capability 2320 enabling flight to an over watch position relative to vehicle 2310. Airship 2340 may then provide relay communications to vehicle 2310 via communications links 2332 and 2334. While relay communications 2330, 2332, 2340, and 2334 to vehicle 2310 are illustrated only for step “D”, relay communications are preferably available for all operational steps after separation of vehicle 2310 from airship 2340. In a preferred embodiment, residual controller 2320 comprises an intelligent navigation assistant. From the over watch position, the intelligent navigation assistant may scan terrain ahead of vehicle 2310 to assist in determining a preferred path. Step “F” illustrates vehicle 2310 with hybrid pontoons 116 approaching aquatic surface 2312 under the control of the common controller 100. Step “F” illustrates vehicle 2310 on aquatic surface 2312 with hybrid pontoons 116 deployed under the control of the common controller 100. Step “G” illustrates vehicle 2310 approaching a shore of terrain 2304 under the control of the common controller 100. Step “H” illustrates vehicle 2310 on the shore of terrain 2304 with the payload gondola 124 deployed for operations under the control of the common controller 100. Those skilled in the art, upon reading the teachings of this specification, will appreciate that, under appropriate circumstances, considering such issues as vehicle design, transportation environments, and mission requirements, various operational sequences, such as air-sea-land, land-air-space-air-land, air-sea-subsea-sea-air, etc., may be used with the multi-medium vehicle system.

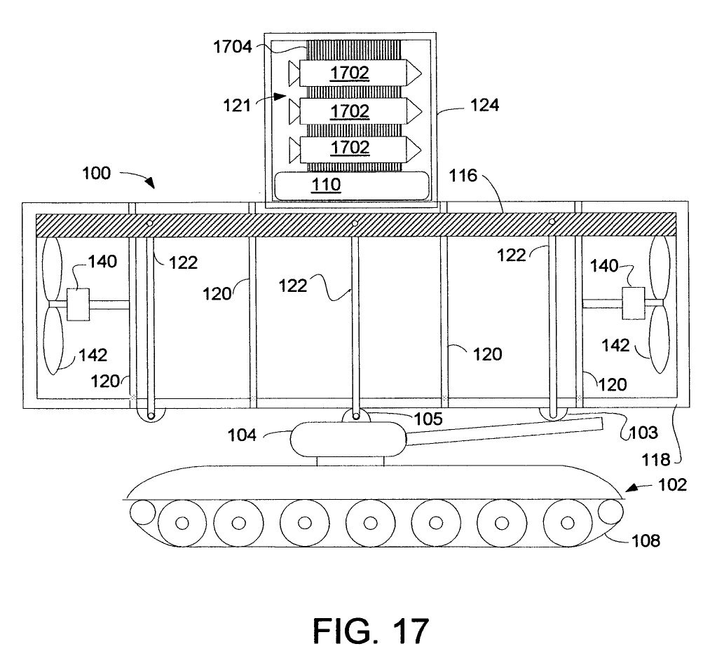

FIG. 17 is a side view illustrating an exemplary embodiment of a multi-medium vehicle system having a payload 121 including rack 1704 and rockets 1702. Rockets 1702 may of any type appropriate for the size of the particular common controller 100. For example, fireworks rockets 1702 may be appropriate for a toy version, while anti-shipping missiles or air-to-air missiles may be appropriate for larger military vehicles. Mounting on the deployed gondola 124 is preferable to avoid the impact of launch exhaust or other launch effects on the common controller 100 or any vehicles coupled thereto. Weapons of various types, including mixed types, may be used as payload 121. For example, for domestic police uses, a combination of a tear gas dispenser, a taser from Taser International of Scottsdale, Ariz., and a flash-bang dispenser, together with surveillance camera may be useful. For further example, a fire control system including a radar and radar-guided air-to-air missiles may be useful for improving survivability during military operations. Those skilled in the art, upon reading the teachings of this specification, will appreciate that, under appropriate circumstances, considering such issues as operational requirements, transportation environments, and economy, various payloads, such as payloads supporting weapons delivery, environmental monitoring, surveillance, communications, border patrolling, drug interdiction, power line maintenance, chemical and radiological monitoring of ships and harbors, etc., may be used with the multi-medium vehicle system.

While sevveral exemplary embodiments haves been presented in the foregoing detailed description, it should be appreciated that a vast number of variations exist. It should also be appreciated that the exemplary embodiments are only examples, and are not intended to limit the scope, applicability, or configuration of the invention in any way. Rather, the foregoing detailed description will provide those skilled in the art with a convenient road map for implementing variations of the exemplary embodiments. It should be understood that various changes can be made in the configuration of elements without departing from the scope of the invention as set forth in the appended claims and the legal equivalents thereof.

What is claimed is:

1) A system for conducting operations relating to various transportation mediums, the system comprising:
a) a plurality of vehicles, wherein
i) each vehicle of said plurality of vehicles is adapted to at least one particular transportation medium of the various transportation mediums; and
ii) each vehicle of said plurality of vehicles is adapted to be coupled to a common controller; and
b) said common controller adapted to be coupled to each particular said vehicle of said plurality of vehicles and operable to at least partially control said each particular vehicle of said plurality of vehicles,
c) wherein at least one coupling between said common controller and said vehicle of said plurality of vehicles comprises a releasable coupling.

2) The system of claim 1, wherein said common controller comprises at least one structure adapted to be mechanically coupled to each said vehicle of said plurality of vehicles.

3) The system of claim 1, further comprising at least one operational payload, wherein said at least one payload is operable to perform at least one task responsive to at least one signal from said common controller.

4) The system of claim 1, wherein said common controller comprises a communication coupling to each particular said vehicle of said plurality of vehicles.

5) The system of claim 4, wherein said common controller comprises a data transfer link operable to transfer data between said common controller and at least one vehicle of said plurality of vehicles.

6) The system of claim 1, wherein said common controller further comprises at least one navigator operable to generate signals operable to at least partially navigate each vehicle of said plurality of vehicles.

7) The system of claim 6, wherein said at least one navigator comprises at least one autonomous navigator operable to store at least one navigation plan and to execute said at least one navigation plan responsive to at least one execution command.

8) The system of claim 6, wherein said common controller further comprises at least one propulsion subsystem.

9) The system of claim 1, further comprising at least one remotely-located communicator, wherein said common controller further comprises at least one local communicator operable to transfer data between said common controller and said at least one remotely-located communicator.

10) The system of claim 9, wherein said local communicator is further operable to transfer data between said common controller and said each vehicle of said plurality of vehicles.

11) The system of claim 9, wherein said at least one remotely-located communicator comprises at least one remote-control console.

12) The system of claim 1, comprising an atmospherically buoyant vehicle configurable to be coupled to said common controller.

13) The system of claim 12, further comprising a ground vehicle, wherein said common controller is further configurable to couple to said ground vehicle.

14) The system of claim 13, wherein said atmospherically buoyant vehicle is configurable to uncouple from said common controller.

15) The system of claim 13, wherein said ground vehicle comprises hybrid pontoons configurable to operate both as obstacle-surmounting devices and as pontoons.

16) The system of claim 1, wherein at least one vehicle of said plurality of vehicles is a variable-configuration vehicle.

17) A method of transporting a payload through a plurality of transportation mediums, comprising the steps of:
a) providing a first vehicle adapted to a first transportation medium of said plurality of transportation mediums, wherein said first vehicle is coupled to said payload;
b) providing a second vehicle adapted to a second transportation medium of said plurality of transportation mediums;
c) providing a common controller adapted to be coupled to at least the first and second vehicles;
d) coupling said first vehicle and said second vehicle to said common controller;
e) propelling said first vehicle with said payload through a first transportation medium of said plurality of transportation mediums using said second vehicle; and
f) subsequently propelling said first vehicle through a second transportation medium of said plurality of transportation mediums using said first vehicle.

18) A multi-medium vehicle comprising:
a) one first vehicle;
b) at least one second vehicle; and
c) at least one common controller detachably coupled to said one first vehicle and detachably coupled to said at least one second vehicle;
d) wherein said at least one common controller is operable to at least assist in controlling operation of said first vehicle and to at least assist in controlling operation of said second vehicle.

19) The multi-medium vehicle of claim 18, wherein said first vehicle comprises a twin-hulled atmospherically buoyant vehicle.

20) The multi-medium vehicle of claim 18, wherein said second vehicle comprises adaptations for operations on a planetary surface.
